(19) United States
(12) Patent Application Publication
(10) Pub. No.: US 2004/0031005 A1
(43) Pub. Date: Feb. 12, 2004

(54) Electronic cad system and layout data producing method therefor

(75) Inventor: Isamu Yunoki, Tateyama-shi (JP)

Correspondence Address: COHEN, PONTANI, LIEBERMAN & PAVANE, 551 FIFTH AVENUE, SUITE 1210, NEW YORK, NY, 10176, US

(73) Assignee: UMC Japan, Tateyama-shi (JP)

(21) Appl. No.: 10/336,996

(22) Filed: Jan. 6, 2003

(30) Foreign Application Priority Data
Mar. 8, 2002 (JP) P2002-064446

(51) Int. Cl. G06F 17/50

(52) U.S. Cl. 716/8; 716/19

(57) ABSTRACT

An electronic CAD system for producing layout data by using data of a predetermined pattern, which employs a novel set of data attributes for reducing the amount of layout data. The system has a layout data production processing unit for producing the following data as the layout data: identification data for a polygon used for designating an area where a plurality of the predetermined patterns are arranged; a set of vertex coordinates of the polygon; identification data of the predetermined pattern; and data for defining intervals at which the predetermined patterns are arranged. Even when patterns are arranged in an undefined area having a shape which cannot be represented by a simple array of the patterns, the array representation is performed by employing the set of vertex coordinates of a polygon for designating an area where the patterns are arranged.

### BACKGROUND OF THE INVENTION

1. Field of the Invention

The present invention relates to (i) an electronic CAD (computer aided design) system suitable for producing layout data used for designing a mask for semiconductor integrated circuit devices, (ii) a method of producing the layout data, and (iii) a computer program for realizing the electronic CAD system by using a computer.

2. Description of the Related Art

Conventionally, electronic CAD systems are used for designing masks for semiconductor integrated circuit devices such as ASICs, DRAMs, and the like. Specific examples of the electronic CAD system include a layout tool for producing layout data, a verification tool for verifying layout data, and a mask data conversion tool for converting layout data into mask data. The layout data produced by the layout data tool is verified by the verification tool, and then converted into mask data by the mask data conversion tool.

Generally, the layout tool, the verification tool, and the mask data conversion tool are supplied by different vendors; thus, it is preferable to use a common data format between the tools. While some common data formats are used, an original format corresponding to a specific vendor may also be used.

Generally, each data format (which also includes the above-explained original format) supports a plurality of data attributes, so as to represent an Array (which will be explained below) in the layout. The data attributes may be (i) the name of an Instance (which will be explained below) of the figure (i.e., pattern) which is repeatedly arranged in the layout, (ii) arrangement pitches on the X and Y axes, (iii) the number of arranged patterns on each of the X and Y axes, and (iv) the position of the first pattern (i.e., the reference pattern for arrangement). Here, the X and Y axes are coordinate axes on the layout. In addition, “the position of the first pattern” is optional and used where necessary.

The Array representation using the conventional data attributes will be explained below. When layout for memory or the like is designed using an ordinary electronic CAD system, the same pattern (corresponding to wiring) is often repeatedly placed several times. Therefore, the same pattern is stored as a cell called an “Instance” in advance, which is later retrieved so as to arrange the pattern at a fixed pitch on each of the X and Y axes. Accordingly, a specific number of the same patterns are arranged on each of the X and Y axes, which (the arrangement of the same patterns) is called an Array.

For example, reference symbol F in FIG. 5 shows a cell which is stored and used as a pattern. This cell F and inverted patterns of the cell F are arranged as shown in FIG. 6, where the 2×2 pattern (cell A) is registered as an Instance. When the layout for area 101 (see FIG. 6) is formed, the already-registered cell A is used for representing and producing an Array of 5×6. Here, the layout data consist of (i) the name of the Instance (here, “cell A”), (ii) arrangement pitches on the X and Y axes (i.e., pitch 1, pitch 2), and (iii) the number of arranged Instances on each of the X and Y axes (here, 5 and 6).

In the above-explained Array representation using the conventional data attributes, the amount of layout data is large and thus the file size of the layout data is large. Accordingly, the memory capacity necessary for storing data files rises, increasing the cost for establishing the electronic CAD system. In addition, such a layout data file having a large file size requires long time for transferring the file via a communication line.

Here, cells A may be arranged in an area 102 as shown in FIG. 7. The area 102 does not have a shape which can be represented by a simple array consisting of cells A (refer to area 101 in FIG. 6). Therefore, the layout for the area 102 cannot be represented by a single array and requires a plurality of arrays. In this case, each array requires the above-explained data attributes, that is, (i) the name of the Instance, (ii) the arrangement pitches on the X and Y axes, (iii) the number of arranged Instances on each of the X and Y axes, and (iv) the position of the first pattern. Therefore, the amount of layout data is increased.

Recently, in accordance with requirements for fine processing and improved dimensional accuracy, cells often should be arranged inside or outside an area having an undefined shape (i.e., a shape which cannot be simply represented using a simple array of the cells). As the amount of layout data is increased, it is desirable to introduce a novel set of data attributes for reducing the amount of layout data.

For example, in order to perform surface smoothing in STI (shallow trench isolation: a fine processing technique), the pattern distribution should be even (i.e., unevenness in the pattern distribution must be prevented). In addition, the dimensional accuracy depends on the degree of unevenness in the pattern distribution. In order to perform fine processing to a degree of 0.18 μm or finer, patterns must be arranged on a mask without unevenness; therefore, dummy patterns are arranged in an area where the pattern distribution is low.

Generally, the dummy pattern is a simple figure such as a square or a rectangle, and such dummy patterns are arranged at a specific arrangement pitch. According to the object for employing the dummy pattern, dummy patterns are inevitably arranged inside or outside an undefined area.

The arrangement pitch for the dummy pattern is generally a few μm; however, in most cases, the arrangement area where the dummy patterns are arranged measures a few hundred μm. Therefore, tens of thousands of dummy patterns can be arranged in a single arrangement area. If a plurality of areas where dummy patterns should be arranged are dispersed within a chip having a size of a few millimeters×a few millimeters, it may be necessary to arrange tens of millions of dummy patterns.

In this case, in order to apply the Array representation using the conventional data attributes to the dummy patterns, in the worst case each dummy pattern requires the above-explained data attributes (i.e., (i) the name of the Instance, (ii) arrangement pitches on the X and Y axes, (iii) the number of arranged Instances on each of the X and Y axes, and (iv) the position of the first pattern), so that the size of the relevant layout data file is huge. As a result, the memory capacity may be insufficient, or the load in data handling such as file conversion or file transfer may be heavier.

### SUMMARY OF THE INVENTION

In consideration of the above circumstances, an object of the present invention is to provide an electronic CAD system which employs a novel set of data attributes for reducing the amount of layout data, and a relevant method of producing layout data. Another object of the present invention is to provide a computer program for realizing the electronic CAD system by using a computer.

The present invention provides an electronic CAD system for producing layout data by using data of a predetermined pattern, where the layout data is used for designing a mask for semiconductor integrated circuit devices, the system comprising:

a layout data production processing unit for producing the following data as the layout data:

identification data for a polygon used for designating an area where a plurality of the predetermined patterns are arranged;

a set of vertex coordinates of the polygon;

identification data of the predetermined pattern; and

data for defining intervals at which the predetermined patterns are arranged.

Accordingly, the layout data can be formed by using the above novel set of data. Therefore, even when patterns are arranged in an undefined area having a shape which cannot be represented by a simple array of the patterns, the array representation is performed by employing the set of vertex coordinates of a polygon for designating an area where the patterns are arranged, so that the amount of layout data can be reduced.

The layout data production processing unit may also produce the following data as a portion of the layout data where necessary: position data of the predetermined pattern as a reference position in the area.

As a specific example, the layout data production processing unit also produces the following data as a portion of the layout data: identification data for a polygon used for designating an area where the predetermined pattern is not arranged, and a set of vertex coordinates of this polygon. In this case, even when patterns are arranged outside an undefined area having a shape which cannot be represented by a simple array of the patterns, the amount of layout data can also be reduced.

The layout data production processing unit may select a pattern to be arranged according to the size of the area where a plurality of the patterns are arranged.

The layout data production processing unit may search for vertexes of the polygon so as to determine the set of vertex coordinates, where the search is performed in consideration of the size of the predetermined pattern so as to detect an area which is smaller than the size of the pattern.

If the layout data production processing unit detects an area which is smaller than the size of the predetermined pattern, the layout data production processing unit may select another pattern in accordance with the size of this area and search for vertexes of a polygon corresponding to this area.

The present invention also provides a method of producing layout data by using data of a predetermined pattern, where the layout data is used for designing a mask for semiconductor integrated circuit devices, the method comprising the step of producing the following data as the layout data:

identification data for a polygon used for designating an area where a plurality of the predetermined patterns are arranged;

a set of vertex coordinates of the polygon;

identification data of the predetermined pattern; and

data for defining intervals at which the predetermined patterns are arranged.

The method may further comprises the step of producing the following data as a portion of the layout data: identification data for a polygon used for designating an area where the predetermined pattern is not arranged, and a set of vertex coordinates of this polygon.

The present invention also provides a computer program for making a computer execute an operation of producing layout data by using data of a predetermined pattern, where the layout data is used for designing a mask for semiconductor integrated circuit devices, the operation comprising a process of producing the following data as the layout data:

identification data for a polygon used for designating an area where a plurality of the predetermined patterns are arranged;

a set of vertex coordinates of the polygon;

identification data of the predetermined pattern; and

data for defining intervals at which the predetermined patterns are arranged.

In the computer program, the operation may further comprise a process of producing the following data as a portion of the layout data: identification data for a polygon used for designating an area where the predetermined pattern is not arranged, and a set of vertex coordinates of this polygon.

According to the present invention, the electronic CAD system can be realized using a computer.

### BRIEF DESCRIPTION OF THE DRAWINGS

FIG. 1 is a block diagram showing the structure of the electronic CAD system as an embodiment according to the present embodiment.

FIG. 2 is a diagram showing an example of the pattern layout produced by the processing unit 1 in FIG. 1.

FIG. 3 shows an example of the data structure of the layout data file 11.

FIG. 4 is a diagram for explaining the layout data producing process performed by the processing unit 1 in FIG. 1.

FIG. 5 is a diagram showing an example of the cell used as a pattern.

FIG. 6 is a diagram for explaining a conventional layout data producing method.

FIG. 7 is also a diagram for explaining the conventional layout data producing method.

### DESCRIPTION OF THE PREFERRED EMBODIMENTS

Hereinafter, an embodiment according to the present invention will be explained with reference to the drawings.

In the embodiment, a novel set of data attributes (1) to (4) for the layout data is defined:

Attribute (i): the name of an Instance of the pattern arranged in the layout (i.e., identification data for the pattern),

Attribute (ii): arrangement pitches on the X and Y axes (i.e., data for defining intervals at which the patterns are arranged),

Attribute (iii): a set of vertex coordinates of a polygon for designating the area where the pattern is arranged or the area where the pattern is not arranged, and

Attribute (iv): position data of the first pattern (i.e., the reference pattern for arrangement in a target area), that is, the data indicating the arrangement position or offset.

Here, the X and Y axes are coordinate axes on the layout. The above data attributes are stored in correspondence to each polygon, that is, to identification data for each polygon for designating the area where the patterns are arranged. In addition, Attribute (iv) (i.e., data for positioning the first pattern) is optional and used where necessary.

FIG. 1 is a block diagram showing the structure of the electronic CAD system in the present embodiment. In FIG. 1, reference numeral 1 indicates a processing unit for executing several kinds of processes for supporting design, such as a layout data producing process (i.e., data related to patterning or wiring). Reference numeral 2 indicates a storage device which is accessed by the processing unit 1 and which stores several kinds of data, such as a layout data file 11. Reference numeral 3 indicates an operation section consisting of input devices such as a keyboard, a mouse, and the like. Reference numeral 4 indicates a display section which has a CRT (cathode ray tube), a liquid crystal display, or the like. Reference numeral 5 indicates an input and output interface for inputting or outputting data, into or from a reader/writer of a storage medium (such as a floppy disk), a printer device, or the like. The input and output interface 5 may perform file transfer via a communication line.

The above processing unit 1 may be realized by a dedicated hardware resource. The processing unit 1 may also be realized using memory and a CPU (central processing unit). In the latter case, a program for implementing the functions of the processing unit 1 is loaded and executed in the memory, so as to realize the functions.

The storage device 2 may be a hard disk, a magneto-optical disk, a nonvolatile memory such as a flash memory, a volatile memory such as a RAM (random access memory), or a combination of the above-explained memories.

The storage device 2 may be built into the electronic CAD system or may be included in another device such as a database server (not shown). In the latter case, the electronic CAD system may access the storage device by communication.

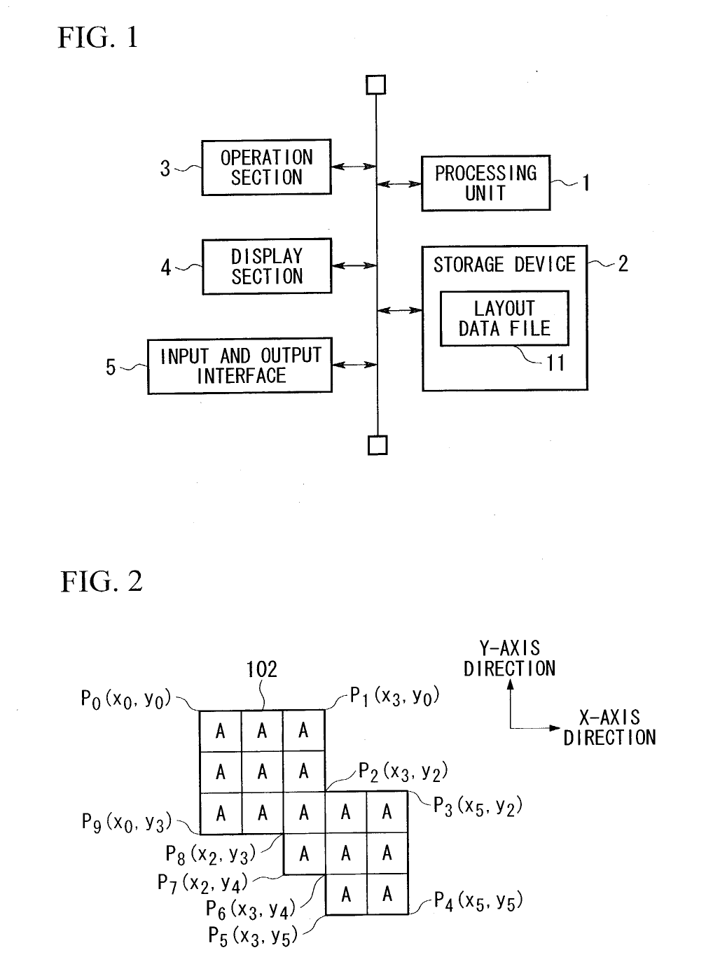

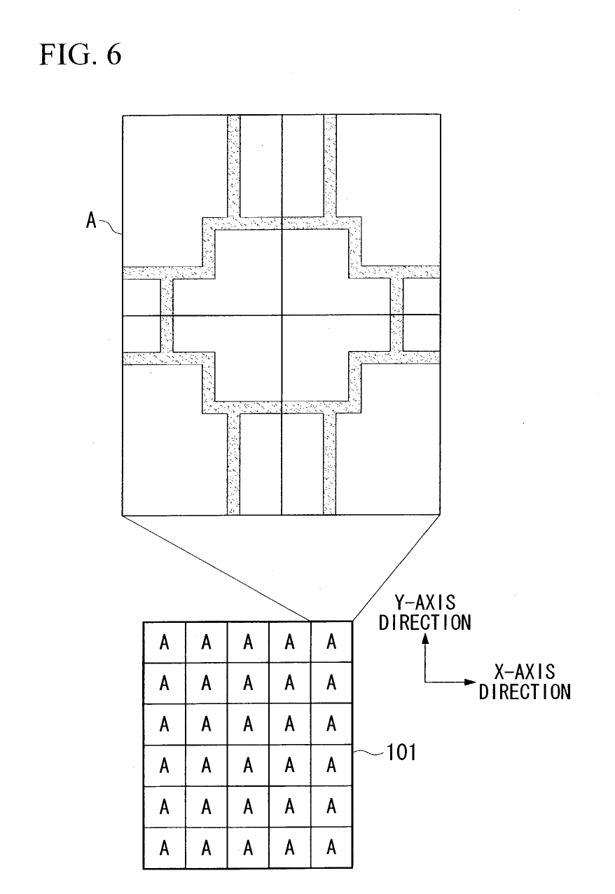

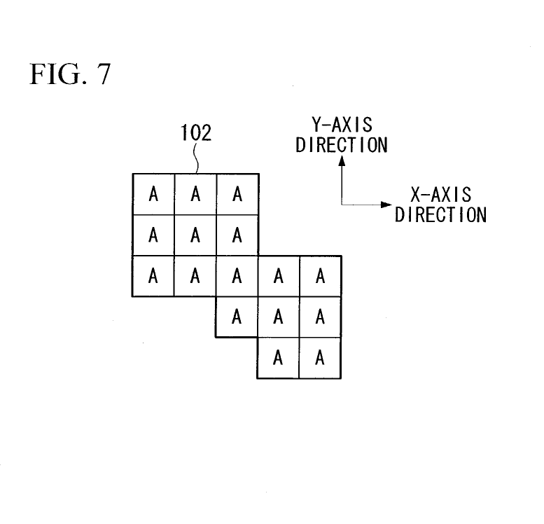

Below, the layout data producing process performed by the processing unit 1 will be explained with reference to FIG. 2. FIG. 2 is a diagram showing an example of the pattern layout produced by the processing unit 1. Similar to the above-explained FIG. 7, in the example shown in FIG. 2, cells A are arranged in the area 102, where the area 102 does not have a shape which can be represented by a simple array of cells A as shown in FIG. 6.

First, the operator designates (i) the area 102 as an area where the patterns are arranged, (ii) cell A as the target pattern to be arranged in the layout, and (iii) “pitch 1”, “pitch 2” as the arrangement pitches on the X and Y axes, and commands to produce layout data by using the operation section 3 while referring to an information display in the display section 4.

According to this command, the processing unit 1 searches the area 102 for vertexes of the polygon. After completing the search, a set of vertex coordinates is produced according to the coordinates of all detected vertexes P₀ to P₉. In the next step, data corresponding to the relevant polygon, that is, (i) the set of vertex coordinates, (ii) the name of the designated Instance (i.e., “A”), (iii) the designated pitches (i.e., pitch 1 and pitch 2), and (iv) data indicating that arrangement is performed (i.e., “arranged”), are stored in the layout data file 11 in the storage device 2.

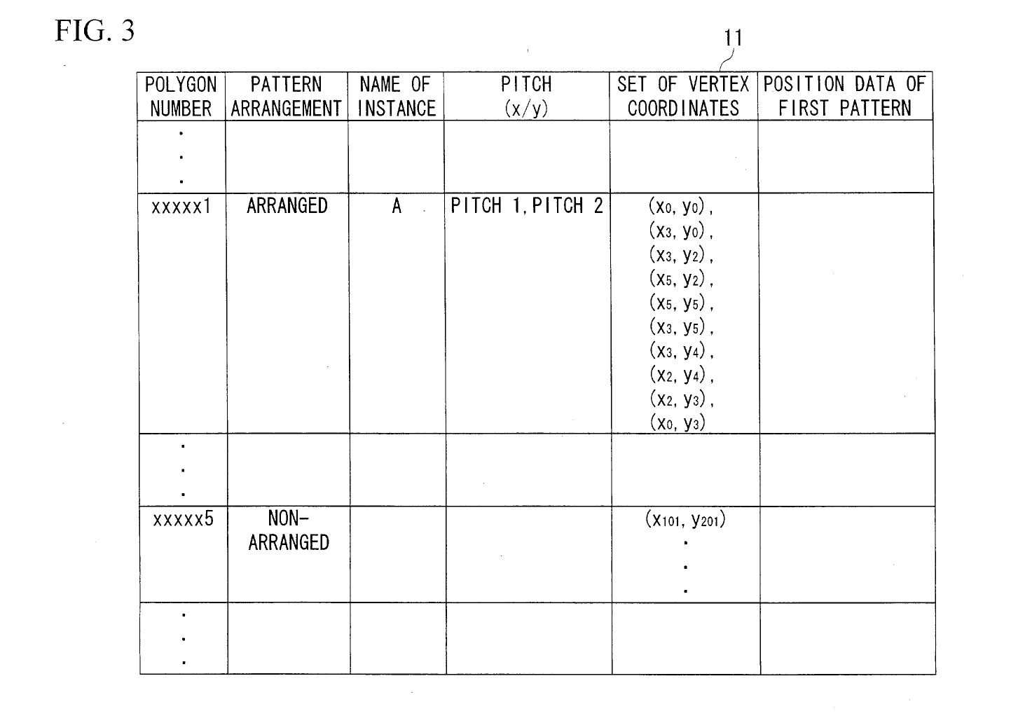

FIG. 3 shows an example of the data structure of the layout data file 11. As shown in the figure, in the layout data file 11, the following data corresponding to the polygon (No. xxxxx1) in the area 102 are stored, that is, (i) “arranged” which indicates that patterns are arranged in this polygon, (ii) “A” which is the name of the Instance, (iii) pitch 1 and pitch 2, and (iv) the set of vertex coordinates (i.e., coordinates of vertexes P₀ to P₉).

As explained above, even when patterns (i.e., cells) are arranged in an undefined area having a shape which cannot be represented by a simple array of the patterns, the array representation is performed by employing the set of vertex coordinates for designating an area where the patterns are arranged, so that the amount of layout data can be reduced.

As for the area designated so that pattern arrangement is not performed, (i) data “non-arranged” and (ii) a set of vertex coordinates are stored in correspondence to the number of the relevant polygon. Accordingly, even when patterns (i.e., cells) are arranged outside an undefined area having a shape which cannot be represented by a simple array of the patterns, the amount of layout data can also be reduced.

The position data of the first pattern may be stored according to the specification of the layout; for example, when the position data can be used for efficiently producing the layout data.

The processing unit 1 may select the pattern to be arranged, according to the size of the “arranged” area. In this case, a plurality of different patterns may be stored in the storage device in advance.

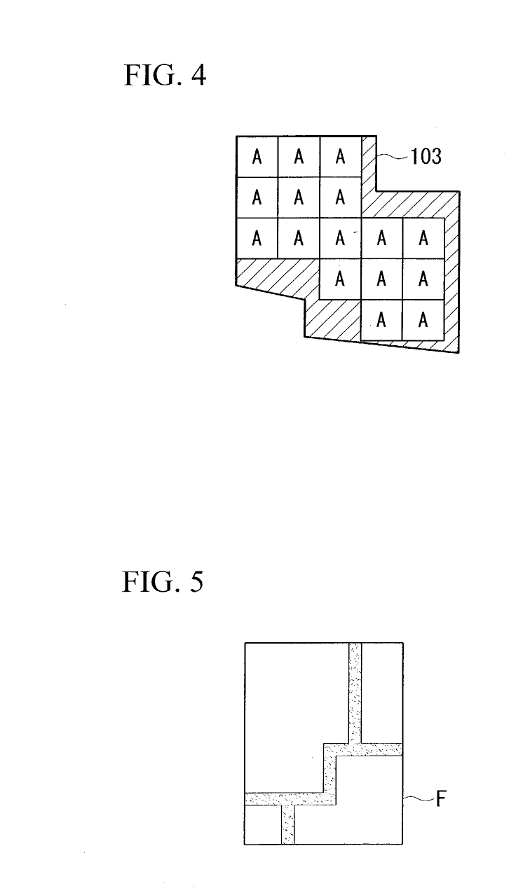

In addition, when searching for the vertexes of the polygon of the “arranged” area, the processing unit 1 may refer to the size of the pattern to be arranged in the layout, so as to detect an area smaller than the size of the pattern. Accordingly, it is possible to detect an area where the designated pattern cannot be placed. For example, if the area 103 shown in FIG. 4 is designated as an “arranged” area, then an area where the pattern (i.e., cell A) cannot be arranged (see the shaded area in FIG. 4) is detected.

As for such an area in which arrangement is not possible, another pattern to be arranged in the layout may be selected in consideration of the size of the area, and a search for vertexes of the polygon corresponding to this area is performed again, so as to produce layout data.

A program for executing the operation of the processing unit 1 shown in FIG. 1 may be stored in a computer readable storage medium, and this stored program may be loaded and executed on a computer system, so as to perform the layout data producing process. The computer system may include hardware resources such as an operating system and peripheral devices.

When using a World Wide Web system, the computer system includes an environment for providing (or displaying) a homepage.

In addition, the computer readable storage medium may be a portable medium such as a flexible disk, magneto-optical disk, ROM, CD-ROM, or the like, or a storage medium built in the computer system, such as a hard disk.

The computer readable storage medium may also be a device for temporarily storing the program, such as volatile memory (i.e., RAM) in the computer system which functions as a server or client for receiving the program sent via a network (e.g., the Internet) or a communication line (e.g., a telephone line).

The above program may be transmitted from the computer system (which stores the program in a storage device or the like) via a transmission medium (on transmissive waves through the transmission medium) to another computer system. The transmission medium through which the program is transmitted is a network such as the Internet or a communication line such as a telephone line, that is, a medium which has a function for transmitting data.

In addition, a program for performing a portion of the above-explained functions may be used. Furthermore, a differential file (i.e., a differential program) to be combined with a program which has already been stored in the computer system may be provided for realizing the above functions.

An embodiment of the present invention has been explained in detail with reference to the drawings; however, the present invention is not limited to the embodiment, and any design modifications are possible within the scope and spirit of the present invention.

What is claimed is:

1. An electronic CAD system for producing layout data by using data of a predetermined pattern, where the layout data is used for designing a mask for semiconductor integrated circuit devices, the system comprising:
a layout data production processing unit for producing the following data as the layout data:
identification data for a polygon used for designating an area where a plurality of the predetermined patterns are arranged;
a set of vertex coordinates of the polygon;
identification data of the predetermined pattern; and
data for defining intervals at which the predetermined patterns are arranged.

2. An electronic CAD system as claimed in claim 1, wherein the layout data production processing unit also produces the following data as a portion of the layout data:
position data of the predetermined pattern as a reference position in the area.

3. An electronic CAD system as claimed in claim 1, wherein the layout data production processing unit also produces the following data as a portion of the layout data:
identification data for a polygon used for designating an area where the predetermined pattern is not arranged, and a set of vertex coordinates of this polygon.

4. An electronic CAD system as claimed in claim 1, wherein the layout data production processing unit selects a pattern to be arranged according to the size of the area where a plurality of the patterns are arranged.

5. An electronic CAD system as claimed in claim 1, wherein the layout data production processing unit searches for vertexes of the polygon so as to determine the set of vertex coordinates, where the search is performed in consideration of the size of the predetermined pattern so as to detect an area which is smaller than the size of the pattern.

6. An electronic CAD system as claimed in claim 5, wherein if the layout data production processing unit detects an area which is smaller than the size of the predetermined pattern, the layout data production processing unit selects another pattern in accordance with the size of this area and searches for vertexes of a polygon corresponding to this area.

7. A method of producing layout data by using data of a predetermined pattern, where the layout data is used for designing a mask for semiconductor integrated circuit devices, the method comprising the step of producing the following data as the layout data:
identification data for a polygon used for designating an area where a plurality of the predetermined patterns are arranged;
a set of vertex coordinates of the polygon;
identification data of the predetermined pattern; and
data for defining intervals at which the predetermined patterns are arranged.

8. A method of producing layout data, as claimed in claim 7, further comprising the step of producing the following data as a portion of the layout data:
identification data for a polygon used for designating an area where the predetermined pattern is not arranged, and a set of vertex coordinates of this polygon.

9. A computer program for making a computer execute an operation of producing layout data by using data of a predetermined pattern, where the layout data is used for designing a mask for semiconductor integrated circuit devices, the operation comprising a process of producing the following data as the layout data:
identification data for a polygon used for designating an area where a plurality of the predetermined patterns are arranged;
a set of vertex coordinates of the polygon;
identification data of the predetermined pattern; and
data for defining intervals at which the predetermined patterns are arranged.

10. A computer program as claimed in claim 9, wherein the operation further comprises a process of producing the following data as a portion of the layout data:
identification data for a polygon used for designating an area where the predetermined pattern is not arranged, and a set of vertex coordinates of this polygon.
